(19) United States
(12) Patent Application Publication
(10) Pub. No.: US 2026/0318881 A1
(43) Pub. Date: Oct. 15, 2026

(54) ULTRASONIC TRANSDUCER

(71) Applicant: QISDA CORPORATION, Taoyuan City (TW)

(72) Inventor: Fu-Sheng JIANG, Taoyuan City (TW)

(73) Assignee: QISDA CORPORATION, Taoyuan City (TW)

(21) Appl. No.: 19/637,198

(22) Filed: Apr. 2, 2026

(30) Foreign Application Priority Data
Apr. 9, 2025 (TW) 114113360

(51) Int. Cl. G01N 29/24

(52) U.S. Cl. CPC G01N 29/2437

(57) ABSTRACT

An ultrasonic transducer includes a transducer layer for transmitting and receiving an ultrasound, wherein the transducer layer includes a plurality of transducing parts and a plurality of spacing parts. The transducing parts are separated from each other by the spacing parts. The transducing parts includes a piezoelectric material. The spacing parts includes an adhesive material, a plurality of hollow glass microspheres, and a plurality of micro-nanometer scale powders, wherein the hollow glass microspheres and the micro-nanometer scale powder are dispersed in the adhesive material, and particle sizes of the hollow glass microspheres are between 0.5 μm and 9 μm.

This application claims the benefit of Taiwan application Serial No. 114113360, filed Apr. 9, 2025, the subject matter of which is incorporated herein by reference.

### BACKGROUND OF THE INVENTION

### Field of the Invention

The invention relates in general to an ultrasonic transducer, and more particularly to an ultrasonic transducer including a transducer layer.

### Description of the Related Art

Ultrasonic transducers have become indispensable examination tools in modern medicine. Generally, an ultrasonic transducer includes a transducer layer. The transducer layer can be used to transmit and receive an ultrasound, and convert between “electrical energy” and “mechanical energy.” However, the transducer layers currently available on the market still suffer from noise problems, which easily interfere with the examination results. Therefore, there is still an urgent need to develop an ultrasonic transducer that improves the noise of the transducer layer.

### SUMMARY OF THE INVENTION

The invention is directed to an ultrasonic transducer, wherein the spacing parts of the transducer layer includes an adhesive material, hollow glass spheres, and micro-nanometer scale powders, thereby avoiding the formation of noise due to the delay trailing phenomenon, and reducing the reflection energy at the interface between the transducing parts and the spacing parts.

According to an embodiment of the present invention, an ultrasonic transducer is provided. The ultrasonic transducer comprises a transducer layer for transmitting and receiving an ultrasound, wherein the transducer layer comprises a plurality of transducing parts and a plurality of spacing parts. The transducing parts are separated from each other by the spacing parts. The transducing parts comprises a piezoelectric material. The spacing parts comprises an adhesive material, a plurality of hollow glass microspheres, and a plurality of micro-nanometer scale powders, wherein the hollow glass microspheres and the micro-nanometer scale powder are dispersed in the adhesive material, and particle sizes of the hollow glass microspheres are between 0.5 μm and 9 μm.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic cross-sectional view of an ultrasonic transducer according to an embodiment of the present invention.

FIG. 2 is a schematic view of the transducer layer in the ultrasonic transducer of FIG. 1 according to an embodiment of the present invention.

FIG. 3 is a schematic view of the transducer layer in the ultrasonic transducer of FIG. 1 according to another embodiment of the present invention.

### DETAILED DESCRIPTION OF THE INVENTION

Various embodiments will now be described in greater detail with reference to the accompanying drawings. The descriptions and drawings are provided for illustrative purposes only and are not intended to be limiting. For clarity, some elements and/or reference numbers may be omitted in some figures. Furthermore, elements in the figures may not be drawn to actual scale. It is anticipated that elements and features from one embodiment may be advantageously incorporated into another embodiment without further redundant description.

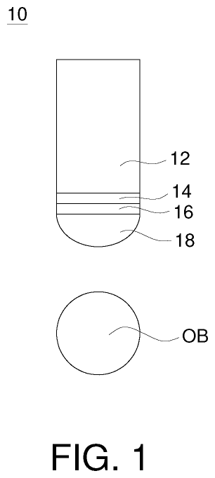

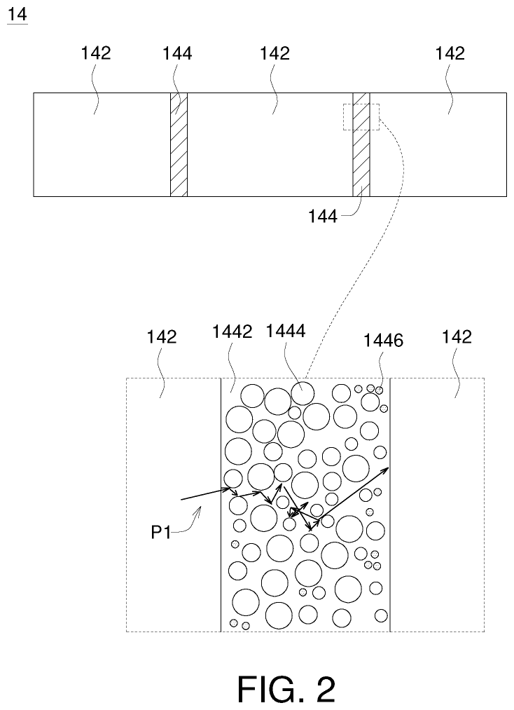

FIG. 1 is a schematic cross-sectional view of an ultrasonic transducer 10 according to an embodiment of the present invention. FIG. 2 is a schematic view of a transducer layer 14 in the ultrasonic transducer 10 of FIG. 1 according to an embodiment of the present invention.

Referring to FIGS. 1 and 2, the ultrasonic transducer 10 includes the transducer layer 14. The transducer layer 14 is used to transmit and receive an ultrasound. The transducer layer 14 includes a plurality of transducing parts 142 and a plurality of spacing parts 144. The transducing parts 142 are separated from each other by the spacing parts 144. The transducing parts 142 include a piezoelectric material, and the spacing parts 144 include an adhesive material 1442, a plurality of hollow glass microspheres 1444, and a plurality of micro-nanometer scale powders 1446. The hollow glass microspheres 1444 and the micro-nanometer scale powders 1446 are dispersed in the adhesive material 1442, and the particle sizes of the hollow glass microspheres 1444 are between 0.5 μm and 9 μm, preferably between 0.7 μm and 5 μm.

The transducer layer 14 is generally cut or diced, thereby forming the plurality of transducing parts 142 and the plurality of spacing parts 144. The plurality of transducing parts 142 in the transducer layer 14 can be regarded as a plurality of oscillating units. Since the transducing parts 142 include the piezoelectric material, the vibrations generated by the oscillating units are transmitted in multiple directions. If the material of the transducer layer 14 cannot effectively suppress the propagation of sound waves, the overall signal will still generate a delay trailing phenomenon due to propagation to adjacent oscillating units, thereby forming noise. Furthermore, the reflection energy at the interface between the transducing parts 142 and the spacing parts 144 will also weaken the signal strength. If the reflection energy is too high, it may cause destructive interference to weaken the signal strength. Both the generation of noise and the weakened signal will lead to interference with the examination results.

According to an embodiment of the present invention, because the spacing parts 144 include the adhesive material 1442, hollow glass microspheres 1444, and the plurality of micro-nanometer scale powders 1446, in which the hollow glass microspheres 1444 and the micro-nanometer scale powders 1446 are dispersed in the adhesive material 1442, and the particle sizes of the hollow glass microspheres 1444 are between 0.5 μm and 9 μm, the spacing parts 144 have the function of vibration isolation. For example, when two adjacent transducing parts 142 (oscillating units) vibrate, the generated mechanical waves transmit in the spacing part 144 disposed between the two adjacent transducing parts 142, because the hollow glass microspheres 1444 have high reflectivity, cause the ultrasound to continuously reflect in the adhesive material 1442, increasing the path of travel (as shown by path P1 in FIG. 2). This causes the mechanical wave generated by the piezoelectric material to attenuate and reduces the transmission to the adjacent transducing part 142 (piezoelectric material), significantly reducing the noise caused by the signal tailing phenomenon in the adjacent oscillating units.

Furthermore, compared to a comparative example where the particle sizes of the hollow glass microspheres are not within the range of 0.5 μm to 9 μm, the spacing parts 144 of the present invention have better damping capacity because the particle sizes of the hollow glass microspheres 1444 are between 0.5 μm and 9 μm.

Although hollow glass microspheres have high reflectivity and can increase the reflection path of ultrasound, the damping effect still needs to consider the attenuation rate of the mechanical waves. Compared to a comparative example where the spacing part includes the adhesive material and hollow glass microspheres but no micro-nanometer scale powder, because the spacing part of the present case also includes micro-nanometer scale powder, the reflectivity can be reduced, and the spacing part has a high attenuation rate, thereby achieving a better vibration isolation effect.

Therefore, the transducer layer 14 of the present invention, on one hand, can prevent noise from being formed by the delay tailing phenomenon, and on the other hand, can reduce the reflection energy at the interface between the transducing parts 142 and the spacing parts 144 (i.e., having high attenuation).

In addition, experimental results confirm that, compared to a comparative example where the spacing parts do not include hollow glass microspheres, because the spacing parts 144 of the present invention include the hollow glass microspheres 1444, the warping degree of the transducer layer 14 can be significantly improved, making it flatter and reducing size variations.

According to some embodiments, the material of the micro-nanometer scale powders 1446 are, for example, tungsten powders, and the particle sizes of the micro-nanometer scale powders 1446 are between 400 nm and 25 μm, preferably between 500 nm and 20 μm. It may be a mixture of different particle sizes.

According to some embodiments, the material of the micro-nanometer scale powders 1446 are, for example, alumina powders, which may be a mixture of different particle sizes. That is, the micro-nanometer scale powders 1446 include large-particle-size micro-nanometer scale powders and small-particle-size micro-nanometer scale powders, where the particle sizes of the large-particle-size micro-nanometer scale powders are between 600 nm and 5 μm, preferably between 700 nm and 3 μm, and the particle sizes of the small-particle-size micro-nanometer scale powders are between 30 nm and 200 nm, such as 70 nm. The smaller particle sizes offer better filling effect.

According to some embodiments, the micro-nanometer scale powders 1446 are alumina powders, silicon dioxide powders, tungsten powders, or any combination thereof. The particle sizes of the silicon dioxide powders are between 1.5 μm and 38 μm, preferably 1.5 μm.

According to some embodiments, the adhesive material 1442 includes epoxy resin.

According to some embodiments, the hollow glass microspheres 1444 have inconsistent particle sizes.

According to some embodiments, the weight ratio range of the adhesive material 1442, the hollow glass microspheres 1444, and the micro-nanometer scale powders 1446 is 3-6:0.1-1:0.1-20.

In one embodiment, the spacing parts 144 include the adhesive material 1442, the hollow glass microspheres 1444, the micro-nanometer scale powders 1446, and silicon dioxide (quartz); the micro-nanometer scale powders 1446 include alumina powders and tungsten powders; the resulting weight ratio among the adhesive material, the hollow glass microspheres, the alumina powders, the tungsten powders and the silicon dioxide powders is 3-6:0.1-1:0.4-2:1-20:0.1-8, where the weight ratio of the hollow glass microspheres is preferably 0.25-1, and the weight ratio of the tungsten powders are preferably 2.25-7. The weight ratio of quartz is preferably 0.1-1.33.

As shown in FIG. 1, the ultrasonic transducer 10 may further include a backing layer 12, a matching layer 16, and an acoustic lens 18. The matching layer 16 and the acoustic lens 18 are sequentially disposed on one side of the transducer layer 14 adjacent to an object OB to be measured. The backing layer 12 is disposed on one side of the transducer layer 14 away from the object OB to be measured. The object OB to be measured is, for example, a human body, a probe, or another suitable object to be measured.

According to some embodiments, the piezoelectric material includes, for example, Lead Zirconate Titanate (PZT), single crystal materials (PMNPT, LiNBO3), quartz, Polyvinylidene Fluoride (PVDF), aluminum nitride (AlN), and/or zinc oxide, but the present invention is not limited thereto.

According to some embodiments, the spacing parts 144 are insulating or have low conductivity to prevent short circuits.

Please refer to the following Table 1, which shows the experimental results of acoustic impedance and attenuation for different groups (Comparative Example A and Embodiments B-D).

TABLE 1

| | Acoustic impedance | Attenuation |
|---|---|---|
| Group | (Mrayl) | (dB/cm) |
| Comparative Example A | 2.8 | −30 |
| Embodiment B | 6.4 | −109 |
| Embodiment C | 6.6 | −95 |
| Embodiment D | 5.8 | −139 |
| Embodiment E | 5.4 | −106 |

In Table 1, Comparative Example A and Embodiments B-D are formulated with different ratios of adhesive material, hollow glass microspheres, and micro-nanometer powders. The adhesive material is epoxy resin, and the micro-nanometer powders can be alumina powders and/or tungsten powders. Comparative Example A only includes the adhesive material, and does not include hollow glass microspheres or micro-nanometer powders. That is, in the composition of Comparative Example A, the weight ratio among the adhesive material, the hollow glass microspheres, the alumina powders, and the tungsten powders is 1:0:0:0. In the composition of Embodiment B, the weight ratio among the adhesive material, the hollow glass microspheres, the alumina powders, and the tungsten powders is 6:0.5:0.5:14. In the composition of Embodiment C, the weight ratio among the adhesive material, the hollow glass microspheres, the alumina powders, the tungsten powders is 4.5:0.25:1:14. In the composition of Embodiment D, the weight ratio among the adhesive material, the hollow glass microspheres, the alumina powders and the tungsten powders is 6:1:1:9. In the composition of Embodiment E, the weight ratio among the adhesive material, the hollow glass microspheres, the alumina powders, the tungsten powders and the quartz is 6:0.66:1.33:4:1.33.

As can be seen from the results in Table 1, compared to Comparative Example A, Embodiments B to Embodiment D all have a higher acoustic impedance and a larger attenuation value. Therefore, the experimental results verify that the addition of hollow glass microspheres and micro-nanometer powders can significantly increase the attenuation rate compared to the comparative example that only has the adhesive material, thereby achieving a better vibration isolation effect.

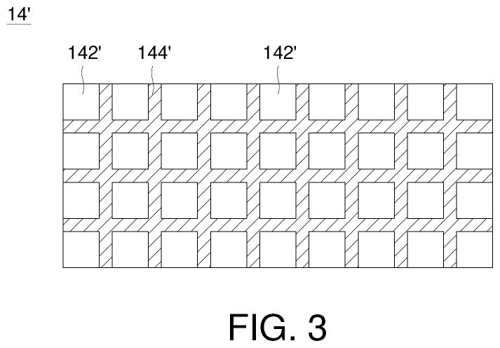

FIG. 3 is a schematic view of the transducer layer 14′ in the ultrasonic transducer 10 of FIG. 1 according to another embodiment of the present invention.

Referring to FIG. 3, the transducer layer 14′ includes a plurality of transducing parts 142′ and a plurality of spacing parts 144′. The materials and functions of the transducing parts 142′ and the spacing parts 144′ are respectively the same as the transducing parts 142 and the spacing parts 144. The difference is that the transducing parts 142′ are arranged in an array, and the spacing parts 144′ are similar to a mesh-like structure. Other same or similar parts will not be described in detail again. The spacing parts 144′ are interconnected and separate the transducing parts 142′ from each other.

In summary, the present invention provides an ultrasonic transducer with improved noise characteristics of the transducer layer. Since the transducer layer of the present invention includes hollow glass microspheres, which have high reflectivity, the tailing phenomenon generated by adjacent oscillating units can be significantly reduced, thus avoiding noise. Furthermore, since the transducer layer of the present invention includes micro-nanometer scale powders, the spacing parts possess a high attenuation rate, which achieves an even better vibration isolation effect.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An ultrasonic transducer, comprising:
a transducer layer for transmitting and receiving an ultrasound, wherein the transducer layer comprises a plurality of transducing parts and a plurality of spacing parts, the transducing parts being separated from each other by the spacing parts, the transducing parts comprising a piezoelectric material, and the spacing parts comprising an adhesive material, a plurality of hollow glass microspheres, and a plurality of micro-nanometer scale powders, wherein the hollow glass microspheres and the micro-nanometer scale powder are dispersed in the adhesive material, and particle sizes of the hollow glass microspheres are between 0.5 μm and 9 μm.

2. The ultrasonic transducer according to claim 1, wherein particle sizes of the micro-nanometer scale powders are between 30 nm and 38 μm.

3. The ultrasonic transducer according to claim 1, wherein the micro-nanometer scale powders are alumina powders, silicon dioxide powders, tungsten powders, or any combination thereof.

4. The ultrasonic transducer according to claim 3, wherein a weight ratio of the adhesive material, the hollow glass microspheres, the alumina powders, the tungsten powders, and the silicon dioxide powders is 3-6:0.1-1:0.4-2:1-20:0.1-8.

5. The ultrasonic transducer according to claim 3, wherein particle sizes of the tungsten powders are between 500 nm and 20 μm.

6. The ultrasonic transducer according to claim 3, wherein the alumina powders comprise large-particle-size powders and small-particle-size powders, particle sizes of the large-particle-size powders are between 600 nm and 5 μm, and particle sizes of the small-particle-size powders are between 30 nm and 200 nm.

7. The ultrasonic transducer according to claim 1, wherein the hollow glass microspheres have inconsistent particle sizes.

8. The ultrasonic transducer according to claim 1, wherein the adhesive material comprises epoxy resin.

9. The ultrasonic transducer according to claim 1, wherein a weight ratio of the adhesive material, the hollow glass microspheres, and the micro-nanometer scale powders is 3-6:0.1-1:0.1-20.

10. The ultrasonic transducer according to claim 1, wherein particle sizes of the hollow glass microspheres are between 0.7 μm and 5 μm.

11. The ultrasonic transducer according to claim 3, wherein particle sizes of the tungsten powders are between 400 nm and 25 μm.

12. The ultrasonic transducer according to claim 6, wherein particle sizes of the large-particle-size powders are between 700 nm and 3 μm.

13. The ultrasonic transducer according to claim 3, wherein particle sizes of the silicon dioxide powders are between 1.5 μm and 38 μm.

14. The ultrasonic transducer according to claim 4, wherein a weight ratio of the hollow glass microspheres is 0.25-1.

15. The ultrasonic transducer according to claim 4, wherein a weight ratio of the tungsten powders are 2.25-7.

16. The ultrasonic transducer according to claim 4, wherein a weight ratio of the silicon dioxide powders are 0.1-1.33.

17. The ultrasonic transducer according to claim 1, further comprising a backing layer, a matching layer, and an acoustic lens, wherein the matching layer and the acoustic lens are sequentially disposed on one side of the transducer layer adjacent to an object to be measured, and the backing layer is disposed on one side of the transducer layer away from the object to be measured.

18. The ultrasonic transducer according to claim 1, wherein the piezoelectric material comprises a material selected from a group consisted of lead zirconate titanate (PZT), single crystal materials, quartz, Polyvinylidene Fluoride (PVDF), aluminum nitride (AlN), and zinc oxide.

19. The ultrasonic transducer according to claim 1, wherein the spacing parts are insulating or have low conductivity.

20. The ultrasonic transducer according to claim 1, wherein the transducing parts are arranged in an array.
